(19) United States
(12) Patent Application Publication
(10) Pub. No.: US 2004/0031372 A1
(43) Pub. Date: Feb. 19, 2004

(54) Floating blade plectrum

(76) Inventor: Peter John Glyde, Burton-on-Trent (GB)

Correspondence Address: PETER J. GLYDE, 471 BURTON RD., MIDWAY, SWADLIN COTE, BURTON-ON-TRENT, STAFFORDSHIRE, DE11 7NB, GB

(21) Appl. No.: 10/615,272

(22) Filed: Jul. 9, 2003

(30) Foreign Application Priority Data
Aug. 7, 2002 (GB) GB 0218294.7
Feb. 13, 2003 (GB) GB 0303240.6

(51) Int. Cl. G10D 3/16

(52) U.S. Cl. 84/320

(57) ABSTRACT

The Floating Blade Plectrum is a general purpose plectrum suitable for all types of acoustic guitar playing. It eliminates all the disadvantages of conventional plectra. It comprises a relatively short thick plastic ‘blade’ connected by a ‘non-rigid attachment’ to two ‘rigidity layers’ made of soft flexible rubber. These are enclosed between two ‘grip layers’ made of soft, flexible, non-slip rubber. Between the ‘rigidity layers’ and the ‘grip layers’ are two ‘moment plates’ made of thin rigid material. The plectrum is held in a pen-holding grip between the thumb and first finger. The grip remains constant, the rigidity of the plectrum is altered by varying the grip pressure. The presence of the ‘moment plates’ increases the sensitivity of the plectrum such that for a similar increase in grip pressure the rigidity of the plectrum is greater; the minimum rigidity is unaltered but the maximum rigidity is increased.

### BACKGROUND OF THE INVENTION

This invention relates to a floating blade plectrum suitable for playing a steel strung acoustic guitar.

### CROSS-REFERENCE TO RELATED APPLICATIONS

U.K. Patent Application; 0218294.7, Filing/Priority Date Aug. 7th 2002.

U.K. Patent Application; 0303240.6, Filing Date; Feb. 13th 2003, Priority Date; Aug. 7th 2002.

### STATEMENT REGARDING FEDERALLY SPONSORED RESEARCH DEVELOPMENT

Not Applicable.

### REFERENCE TO SEQUENCE LISTING, A TABLE, OR A COMPUTER PROGRAM LISTING COMPACT DISK APPENDIX

Not Applicable.

### BRIEF SUMMARY OF THE INVENTION

A plectrum is one means of playing the strings of an acoustic steel strung guitar. Typically a plectrum is an egg-shaped piece of thin plastic approx. 1″ long by ¾″ wide. It is usually held between the thumb and first finger of the playing hand in a pen-holding grip. There are a number of ways in which the plectrum can be used to play the guitar. The strings can be sounded in rapid succession, i.e. strummed or picked individually, i.e. single note playing. A combination of the two styles is called ‘flat picking’. The disadvantages of using conventional plectra are as follows. Firstly, the player cannot easily change the style of playing, say from soft to loud strumming as this requires putting down one plectrum and picking up the next. Secondly, the sound quality obtained with thin plectra is poor due to high plectrum ‘clatter’ or ‘white noise’ compared to the actual musical notes being produced by the instrument. Thirdly, the dynamic control, i.e. the ability to play very softly and very loudly with the same plectrum is poor. Fourthly, conventional plectra are difficult to grip and tend to move and leave the fingers when in use. Fifthly, for fast flat picking and smooth strumming it is advantageous to have the plectrum stiffer on the down stroke than on the up stroke, conventional plectra cannot provide this. The floating blade plectrum is a single general purpose plectrum which eliminates all the listed disadvantages.

### BRIEF DESCRIPTION OF THE SEVERAL VIEWS OF THE DRAWING

FIG. 1 shows the ‘blade’, 1, with ‘non-rigid attachment’, 2.

FIG. 2 shows the ‘blade’, 1, with ‘non-rigid attachment’, 2, with upper ‘rigidity layer’, 3, and lower ‘rigidity layer’, 4, fixings, 5 & 6, and ‘rigidity layer’ contours, 7 & 8.

FIG. 3 shows the ‘blade’, 1, with ‘non-rigid attachment’,2, with upper ‘rigidity layer’, 3, and lower ‘rigidity layer’, 4, upper ‘grip layer’, 9, lower ‘grip layer’, 10, upper ‘moment plate’, 11, and lower ‘moment plate’, 12.

### DETAILED DESCRIPTION OF THE INVENTION

A conventional plectrum is typically an egg-shaped piece of thin plastic approx. 1″ long by ¾″ wide. The Floating Blade Plectrum is totally different in operation and construction retaining only a short relatively thick blade of approx. ½″ long by ¾″ wide.

According to the present invention there is provided a ‘blade’ of relatively thick plastic material with a ‘non-rigid attachment’ between this and two ‘rigidity layers’. The upper and lower ‘rigidity layers’ are each made of a soft, flexible material of uniform thickness, the upper layer being of greater thickness than the lower. The ‘rigidity layers’ can be contoured to adjust the rigidity they confer to the plectrum. The ‘rigidity layers’ are enclosed between two ‘grip layers’. Each ‘grip layer’ is made of a soft flexible non-slip material or a soft flexible material coated with a soft,flexible non-slip surface. Each ‘grip layer’ is of uniform thickness and the thickness of each is the same. There is a ‘moment plate’ of relatively thin rigid material one above the ‘blade’ and one below the ‘blade’ making two in all. Each ‘moment plate’ may be attached above or below the ‘grip layer’ or ‘rigidity layer’ or embedded within the ‘grip layer’ or ‘rigidity layer’.

The plectrum is held in a pen-holding grip between the thumb and first finger. When little or no pressure is applied this allows the ‘blade’ to move freely between the ‘rigidity layers’. When maximum pressure is exerted the ‘blade’ is held securely between the finger and thumb. Varying the grip pressure between the two extremes gives a plectrum of infinitely varying rigidity. The presence of the ‘moment plates’ increases the sensitivity of the floating blade plectrum such that for a similar increase in grip pressure the rigidity of the plectrum is greater; the minimum rigidity is unaltered but the maximum rigidity is increased. The different thicknesses of the ‘rigidity layers’ means that the plectrum is always stiffer on the down stroke than on the up stroke.

A specific embodiment of the invention will now be described by way of example with reference to the accompanying drawing, in which;

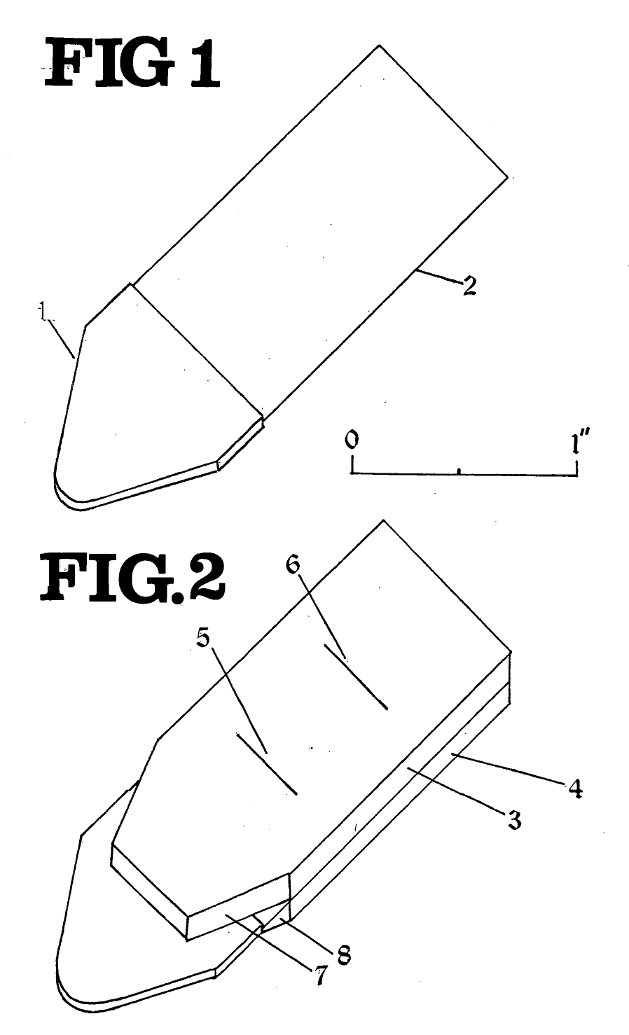

FIG. 1 shows in perspective the ‘blade’ with ‘non-rigid attachment’.

FIG. 2 shows in perspective the ‘blade’ with ‘non-rigid attachment’ fixed to the ‘rigidity layers’.

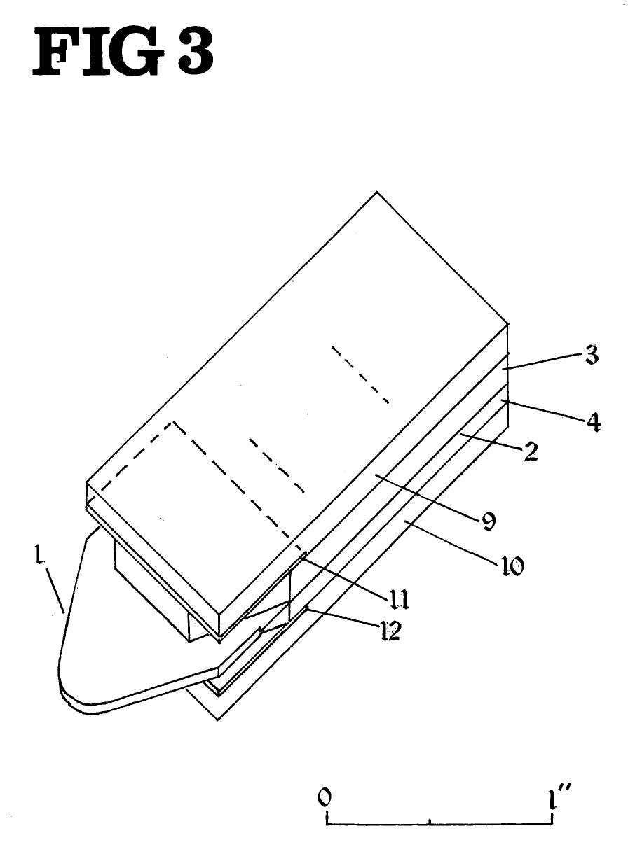

FIG. 3 shows in perspective the above with ‘grip layers’ and ‘moment plates’ to make the complete floating blade plectrum.

Referring to the drawings the floating blade plectrum comprises a ‘blade’,1, of relatively thick plastic material with a ‘non-rigid attachment’,2, using, for example, close weave cotton fabric attached by epoxy adhesive to the ‘blade’ as shown in FIG. 1. Upper and lower ‘rigidity layers’, 3 & 4, are attached by fixings, 5 & 6, as shown in FIG. 2 using, for example, staples. The ‘rigidity layers’, 3 & 4, have been contoured, 7 & 8, to adjust the rigidity they confer to the plectrum as shown in FIG. 2. The ‘grip layers’, 9 & 10, are attached to the ‘rigidity layers’, 3 & 4, as shown in FIG. 3 by, for example, adhesive backing already present on one side of the ‘grip layers’,9 & 10, or the application of a rubber solution based adhesive which is soft and flexible on setting. The ‘moment plates’, 11 & 12, are attached to the ‘grip layers’, 9 & 10, the underside of the upper ‘grip layer’ and the upper side of the lower ‘grip layer’ by, for example, the application of a rubber solution based adhesive. The trailing edge of each ‘moment plate’ extends beyond the rear edge of the ‘blade’.

What I claim as my invention is:

1. A floating blade plectrum comprising a ‘blade’ of relatively thick plastic material with a ‘non-rigid attachment’ between the ‘blade’ and two
‘rigidity layers’ each ‘rigidity layer’ being made of a soft flexible material of uniform thickness, the upper layer being of greater thickness than the lower, the rigidity layers may be contoured to adjust the rigidity they confer to the plectrum, with the ‘rigidity layers’ being enclosed between two
‘grip layers’, each being of uniform thickness and each being of the same thickness, each being of a soft and flexible non-slip material or a soft and flexible material with a soft, flexible, non-slip coating, a
‘moment plate’ of relatively thin rigid material, one above the ‘blade’ and one below the ‘blade’ making two in all, each ‘moment plate’ may be attached above or below the ‘grip layer’ or ‘rigidity layer’ or embedded within the ‘grip layer’ or ‘rigidity layer’.

2. A floating blade plectrum as claimed in claim 1 wherein the ‘blade’ is made from hard nylon material and the
‘non rigid attachment’ comprises close weave cotton fabric joined to the ‘blade’ by epoxy adhesive and the
‘rigidity layers’ comprise soft, flexible, rubber of uniform thickness, the upper layer being of greater thickness than the lower, the ‘rigidity layers’ may be contoured to adjust the rigidity they confer to the plectrum and the
‘grip layers’ comprise adhesive backed soft, flexible, non-slip micro-cellular rubber of uniform thickness or adhesive backed soft, flexible, micro-cellular rubber of uniform thickness with a non-slip coating, the upper and lower ‘grip layer’ being of the same thickness and the
‘moment plates’ are made from thin aluminium alloy plate of uniform thickness and the
‘upper‘moment plate’ is attached to the underside of the upper ‘grip layer’ by a rubber solution based adhesive and the lower ‘moment plate’ is attached to the upper side of the lower ‘grip layer’ by a rubber solution based adhesive.
